(19) United States
(12) Patent Application Publication
(10) Pub. No.: US 2012/0239584 A1
(43) Pub. Date: Sep. 20, 2012

(54) NAVIGATION TO DYNAMIC ENDPOINT

(75) Inventors: Eran Yariv, Zichron Yaakov (IL); Gur Kimchi, Bellevue, WA (US); Barney Darryl Pell, San Francisco, CA (US); Yair E. Gheva, Zichron Yaakov (IL); Brian Beckman, Newcastle, WA (US); Elad Ben-Israel, Tel-Aviv (IL)

(73) Assignee: MICROSOFT CORPORATION, Redmond, WA (US)

(21) Appl. No.: 13/052,093

(22) Filed: Mar. 20, 2011

(51) Int. Cl. G01C 21/00; G06Q 99/00

(52) U.S. Cl. 705/319; 701/302

(57) ABSTRACT

Turn-by-turn directions can guide a user to a dynamic destination, such as a person or a rendezvous location. The turn-by-turn directions enable one user to follow another or, alternatively, multiple people to rendezvous with each other. The selection can be via identifiers used in network contexts, such as social networking Individuals can select the circumstances under which their location can be revealed. Turn-by-turn directions enabling following utilize anticipated locations or predictions of likely destinations based on historical and contextual information. Turn-by-turn directions enabling rendezvous reference a rendezvous location, which is either the same for all users, or which differs among them. Also, the directions can reference intermediate, “staging”, locations from which further intermediate, or ultimate, destinations can be routed to.

### BACKGROUND

Portable computing-based navigational aids are well known in the art. Typically, such aids provide detailed directions to enable a user to travel from an origin location to a fixed destination location, typically specified by an address, while performing another task, such as operating a moving vehicle. Detailed directions are typically in the form of so-called “turn-by-turn” instructions that inform the user, at the appropriate time, of each turn, or other change in the direction of travel, that the user is to perform in order to travel from the origin location to a destination location. Such turn-by-turn instructions are particularly advantageous to users operating a moving vehicle, because they enable the user to continue to focus on the task of operating the moving vehicle safely, and do not cause the user to be distracted by reading a map, or otherwise performing any action relative to determining the navigation path themselves.

Portable computing-based navigational aids are typically either a dedicated portable computing device that is directed solely, or at least primarily, to the task of providing turn-by-turn directions, or they are a multi-use portable computing device, such as a cellular telephone, or vehicle audio component, that can provide turn-by-turn directions while also performing other tasks, such as enabling the user to make cellular telephone calls, or listen to music. To provide increased responsiveness, portable computing-based navigational aids also typically comprise a locally stored database of fixed destination locations, such as street addresses, to which the user can request turn-by-turn directions. Such turn-by-turn directions can, then, be computed by the portable computing-based navigational aid based on the known location of the specified fixed destination, such as can be obtained from the locally stored database, and the known current location of the user, such as can be obtained from a Global Positioning System (GPS) mechanism, or other location determining mechanism, that can be part of the portable computing-based navigational aid.

### SUMMARY

In one embodiment, rather than navigating to a fixed destination location, a user can be provided with detailed directions, such as turn-by-turn directions, to a dynamic destination, or a destination that is not fixed and can be moving. The dynamic destination can be one or more people, or, more particularly, the location of one or more people or the location of one or more computing devices co-located with the one or more people. Alternatively, the dynamic destination can be influenced by the locations of one or more people. In such a manner, a user can be routed to another person or group of people, irrespective of their location and whether they are stationary or moving.

In another embodiment, location information can be collected from users and can be shared with other users for purposes of enabling one user to follow another, or for enabling a group of users to rendezvous. To protect user privacy, location information of any given user can be shared with others only to the extent that that user permits access, by others, to such location information. Flexible options can enable users to allow their location information to be shared only with other specific users, only during specific times of day, only when the users whose location is to be shared are within a predefined geographic area, or other like flexible options.

In a further embodiment, one user can select one or more other users that the first user wishes to follow, or with whom the first user wishes to rendezvous, based on any identifier associated with such one or more other users. Such identifiers can include aliases, handles, or other identifiers utilized in other contexts, such as social networking contexts, c-commerce contexts and other like contexts. To provide for such functionality, a user's location can be associated with a collection of identifiers that identify such a user, and interoperability can be established between services that can collect, or otherwise obtain, a user's location, and network services within which the user is associated with the collection of identifiers.

In a still further embodiment, one user can be provided with detailed directions to another user, thereby enabling the first user to “follow” the second user. The detailed directions can be derived based on a current location and direction of the second user, or they can be derived based on a predicted location of the second user. Predicted locations can be based on that second user's rate and direction of travel, as well as other contextual and historical information about that second user, and contextual information about the area currently surrounding the second user.

In a yet further embodiment, multiple users can be provided with detailed directions to one another, thereby enabling the group of multiple users to “rendezvous” with each other. Each user in the group of users can be provided with detailed directions to the same location, thereby providing for a rendezvous at a precise location, or each user in the group of users can be provided with detailed directions to user-specific locations that can vary among the users in the group, thereby providing for a rendezvous in a general area. The detailed directions provided can be to intermediate, or “staging”, locations from which further detailed directions can be provided, either to further intermediate locations, or to the final rendezvous locations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of one exemplary “following” of one user by another;

FIG. 2 is a diagram of another exemplary “following” of one user by another;

FIG. 3 is a diagram of one exemplary “rendezvous” of multiple users;

FIG. 4 is a diagram of one exemplary “rendezvous” of a dynamic collection of multiple users;

FIG. 5 is a diagram of another exemplary “rendezvous” of multiple users;

FIG. 6 is a flow diagram of an exemplary “following” of one user by another;

FIG. 7 is a flow diagram of an exemplary “rendezvous” of multiple users; and

FIG. 8 is a block diagram of an exemplary computing device.

### DETAILED DESCRIPTION

The following description relates to the provision of detailed directions to a user in order to guide that user to a dynamic destination that can be the location of one or more individuals, or that can be a location that is influenced by the locations of one or more individuals. The detailed directions can enable the user receiving them to select a person to “follow” or, alternatively, to select multiple people with which to “rendezvous”. The selection of one or more individuals can be via identifiers used by such individuals in network contexts, such as a social networking context or an e-commerce context. The location of each person can be obtained, such as through GPS data, signal triangulation, or other known mechanisms. The location can be linked to identifiers of such individuals and the network contexts within which such identifiers exist, thereby enabling such individuals to select, through such network contexts, the circumstances, if any, under which their location can be revealed to others. Such circumstances can be defined by specific individuals, specific times of day, specific geographic regions, and other determinants. Detailed directions enabling one user to follow another, selected, user can be based on the selected user's anticipated location, based on current rate and direction of travel or they can be based on predictions of likely destinations of the selected user. Such predictions can be based on geographic information as well as historical and contextual information. Detailed directions enabling multiple users to rendezvous can be based on a rendezvous location, which can be the same for all users, or which can differ for one or more of the users, such as if the rendezvous only needed to occur within a defined area, as opposed to at a specific location, or the turn-by-turn directions can be based on intermediate, “staging” locations from which further intermediate, or ultimate, destinations can be selected and routed to.

The techniques described herein focus on the provision of turn-by-turn directions within larger geographic contexts, such as a metropolitan region. The mechanisms described, however, can be equally utilized, without modification, to generate detailed directions irrespective of the geographic context, including, for example, detailed directions within a campus context, multi-floor office building context, and other like contexts. Similarly, the mechanisms described, while they are described within the context of navigating a motor vehicle, can be equally utilized, without modification, to provide directions within the context of a user traveling on foot, utilizing public transportation, or any other mode of transportation. As such, the term “turn-by-turn directions” is not meant to limit the below descriptions to directions provided only to a user within the context of navigating a motor vehicle. Instead, utilization of the term “turn-by-turn directions” means the provision of any set of detailed, step-by-step directions, especially as to changes in direction, that are provided to a user at the time and location when such changes in direction are to be executed by the user, irrespective of the geographic context within which such detailed directions are provided, and irrespective of the mode of transportation utilized to execute such directions.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

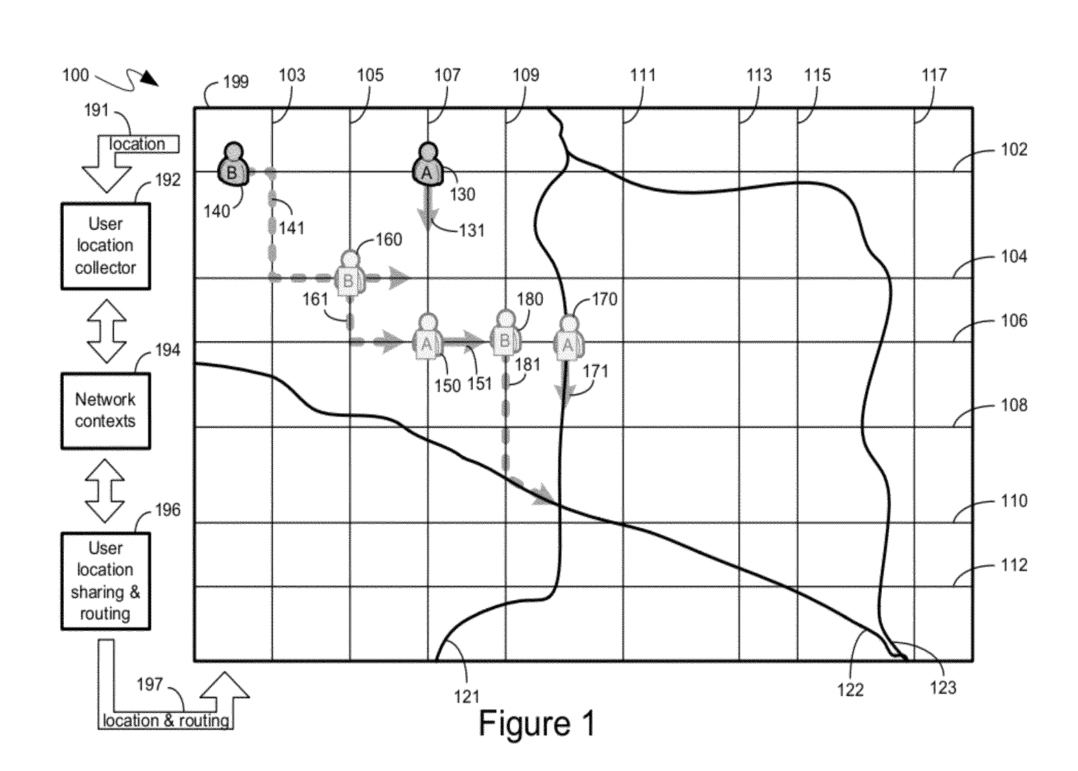

Turning to FIG. 1, the system 100 illustrates a geographical region 199 within which are located two individuals, nominated “A” and “B”, whose initial locations are the locations 130 and 140, respectively, as shown in the geographic region 199. For purposes of illustration, the geographic area 199 is shown as comprising north/south streets 103, 105, 107, 109, 111, 113, 115 and 117 and is further shown is comprising east/west streets 102, 104, 106, 108, 110 and 112. Additionally, again for purposes of illustration, the geographic area 199 is shown as comprising three highways, namely the highways 121, 122 and 123. As indicated previously, such a geographic region is provided as an example only, and the below descriptions are equally applicable to other geographic regions and other sets of navigation instructions, including geographic regions comprising public transportation, or pedestrian traffic only, and including set of navigation instructions directed to utilizing known schedules or aspects of public transportation or directed to walking along a specified path.

The locations of particular individuals, such as the locations of the individuals “A” and “B” shown in the geographic region 199, can be obtained by a user location collector 192. In one embodiment, the location information 191 can be obtained from sensors proximate to individual users that directly measure those users' location, such as sensors that utilize the well-known Global Positioning System (GPS). For example, as will be known by those skilled in the art, many modern computing devices that provide detailed directions, such as turn-by-turn instructions, including dedicated, navigation-specific, computing devices and also more general computing devices, such as cellular telephones and vehicular audio systems, also comprise GPS sensors that can determine an accurate location of the computing device comprising those sensors. In another embodiment, however, the location information 191 can be obtained by indirect means. For example, the location information 191 can be obtained by triangulating wireless signals that may be sent by a navigation-capable computing device co-located with the individual users. Alternatively, the location information 191 can be obtained through observation and deduction such as, for example, by determining the location of a navigation-capable computing device, co-located with an individual user, based on the location of a local wireless network to which such a navigation-capable computing device is communicationally coupled.

In one embodiment, the user location collector 192 can interface with one or more network contexts 194 to associate the obtained information with one or more users via user identifiers utilized to identify such users within specific network contexts. For example, the network contexts 194 can comprise social networking contexts. As will be known by those skilled in the art, users of such social networking contexts select for themselves one or more identifiers with which they can be identified within those social networking contexts. The location information 191 for such users, that is received by the user location collector 192 can, via the interface between the user location collector 192 and the network contexts 194, be associated with one or more identifiers of such users within social networking contexts. In such a manner, as will be described in further detail below, a user can be identified and selected, for purposes of the below-described mechanisms, by their identifier within the social networking context. Similarly, such a user can utilize existing social networking contexts to establish certain privacy restrictions, such as, for example, limiting which other individuals can be granted access to that user's location, time periods during which that user's location may be made available to other individuals, geographic areas within which that user's location may be made available to other individuals, and other like restrictions, which can be applied either individually or in combination.

With reference to various established network contexts 194, a user location sharing mechanism 196 can provide location information 197 to other users, thereby enabling those other users to receive detailed directions, such as turn-by-turn instructions, with which they can be guided to follow other users, or to rendezvous with other users. Additionally, should the computing device that is co-located with individual users not be capable of generating detailed directions, or if it is more efficient to centrally generate such directions, the user location sharing mechanism 196 can further comprise a routing mechanism as well that can provide location and routing information 197.

As an example of the utility of the user location information 197 that can be provided to other users, reference is made to the exemplary users “A” and “B” whose locations are illustrated in the geographic region 199 shown in the system 100 of FIG. 1. Initially, a user “A” can be at the location 130, as illustrated in the geographic region 199, and can be traveling in a southward direction, as illustrated by the vector 131. A different user “B” can be at the location 140, as also illustrated in the geographic region 199, and can desire to follow the user A. For example, the user A may be more familiar with the geographic region 199 and can be leading user B to a destination that is of interest to both. Alternatively, the user A may have forgotten something of importance that user B seeks to deliver to them as efficiently as possible. In such cases, the user B can select, such as through a navigation-capable computing device that is co-located with the user B, the user A as the destination to which the user B seeks to be routed to. Thus, instead of selecting a fixed endpoint, such as is the case with typical navigational systems, the user B can, instead, select a dynamic endpoint whose location may be both variable and currently varying. More specifically, the user B can select another individual, namely the user A, as the endpoint to which the user B seeks to be routed to.

If the user A has allowed their location to be revealed to the user B, then a routing between the user B and the user A can be determined and provided to the user B. In one embodiment, the user A can allow their location to be revealed to the user B through settings that can be accessed via one or more social networking contexts to which the user A belongs. For example, as will be known by those skilled in the art, typical social networking contexts provide for a myriad of options for protecting user privacy and specifying which information can be disseminated to which groups of people. In a similar manner, the user A could utilize such typical social networking contexts to specify specific ones, or groups, of individuals to whom the location of the user A could be revealed. Alternatively, or in addition, the user A could specify particular times of the day during which their location could be revealed. For example, if the user A was employed in a capacity in which their location needed to be known, then the user A could specify that their location could be revealed during normal business. As another example, if the user A wanted to enable their friends to meet up with user A, then user A could specify that their location could be revealed between the hours of, for example, 7 and 10 PM. As yet another criteria by which the revelation of a user's location could be controlled, the user A can specify particular geographic areas within which their location can be revealed. Thus, for example, the user A could specify that their location can be revealed to others if the user A is within a downtown area. In another embodiment, rather than establishing the criteria by which the revelation of a user's location can be controlled via a network context, such as a social networking context, a user can establish the criteria by which the revelation of their location can be controlled through options that can be presented to the user as part of a navigation-capable computing device that is co-located with the user and that can be providing the location information 191 in the first place.

As indicated, if the user A has allowed their location to be revealed to the user B then a routing between the user B and the user A can be determined and provided the user B to enable the user B to follow the user A. For example, in the embodiment illustrated by the system 100 of FIG. 1, the user B, while in the location 140, can select the user A, such as by selecting an appropriate identifier of the user A, such as via a navigation-capable computing device co-located with the user B. If the user A has allowed their location to be revealed to the user B, then the navigation-capable computing device co-located with the user B can either be provided merely the location information 197 of the user A, and the computing device itself can derive detailed routing information and present such information, such as in the form of turn-by-turn directions, to the user B, or, alternatively, the computing device can be provided with both location and routing information 197, and the routing information can be derived remotely, such as by the user location sharing and routing mechanism 196.

In one embodiment, the user B can be routed to follow the user A based upon a current location of the user A, such as the location 130, and a direction and speed in which the user A is moving, such as that illustrated by the vector 131. In such an embodiment, the user B at the location 140 can be provided with a routing analogous to the routing 141 illustrated in the system 100 of FIG. 1, whereby the user B would follow the user A as the user A traveled southbound on the street 107 past the intersection of the street 104. In such an embodiment, the routing provided to the user B, such as the routing 141, can be reevaluated if the user A, to which the user B is being routed, changes direction, if the user B deviates from the routing, such as the routing 141, provided, or if environmental factors, such as traffic or road closures render the routing 141 impractical or inefficient. Deriving an updated routing due to a deviation of the user B from the routing that was provided, such as the routing 141, can be performed in accordance with known mechanisms for rerouting a user back onto a previously derived and provided routing. Similarly, deriving an updated routing due to a change in one or more environmental factors can, likewise, be performed in accordance with known mechanisms for routing a user around environmental impacts, such as traffic road closures, given an already existing routing. However, continual reevaluation of the routing provided to the user B, such as the routing 141, based on the dynamic and changing nature of the location of the user A, can, in one embodiment, be performed in accordance with that illustrated in FIG. 1.

More specifically, as illustrated in the exemplary system 100 of FIG. 1, if, for example, the user A were to turn eastbound on the street 106 when the user A reached the location 150, as illustrated by the vector 151, the routing 141, previously provided to the user B, may no longer be valid for enabling the user B to follow the user A. Instead, the routing provided to the user B can be dynamically changed based on the changing location of the user A. Thus, in the exemplary system 100 of FIG. 1, as the user A changes their direction at the location 150, the user B can be at the location 160 following the previously provided routing 141. The change in direction of the user A at the location 150 can cause a new routing 161 to be provided to the user B at the location 160 to enable the user B to continue to follow the user A. Likewise, when the user A reaches the location 170, the user A can merge onto the highway 121 and proceed in the southbound direction, as indicated by the vector 171. Such a change in the direction in which the user A is traveling can, again, result in a change in the routing provided to the user B to enable the user B to continue to follow the user A. When the user A changes direction at the location 170, the user B can be at location 180, and a new routing 181 can be provided to the user B at the location 180, thereby enabling the user B to follow the user A. As can be seen from the routings illustrated in the system 100 of FIG. 1, the following of a user, such as the user A, by another user, such as the user B, need not require that the following user, namely the user B in the above example, proceed along the same route taken by the user being followed, namely the user A in the above example. Instead, as can be seen from the routings illustrated, the routings provided to a user can be continuously updated in accordance with the dynamic nature of the endpoint, since the endpoint is a person whose location can change and, in the present example, actually is changing.

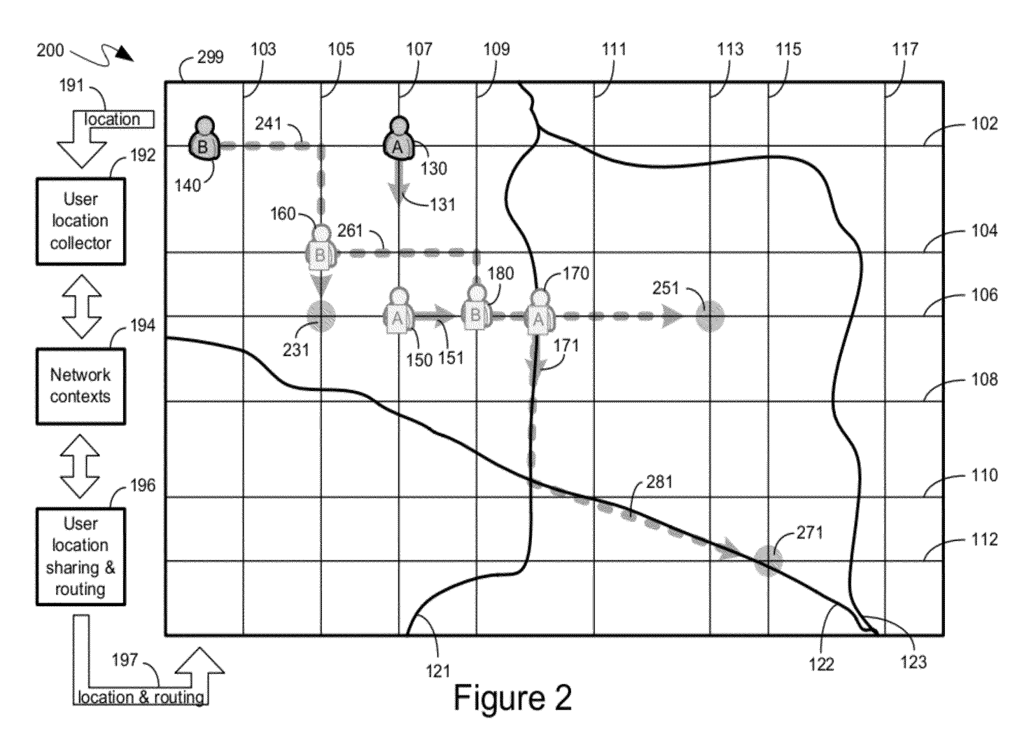

In another embodiment, the routings provided to a user to enable that user to follow another user need not be merely based upon the current location of the user being followed and their direction of travel, it can, instead, be based on a predicted destination of the user being followed. Turning to FIG. 2, the system 200 shown therein comprises a geographic region 299 that is equivalent in scope to the geographic region 199 illustrated in FIG. 1. The geographic region 299 is given a different identifying number to reflect the differences in the routings provided, and in the path taken, by the users A and B. In the system 200 of FIG. 2, the routing provided to the user B that seeks to follow the user A can be based, not on the location and direction of travel of the user A, but rather on a prediction of the user A′s destination. For example, when the user B is at the location 140, and selects that they wish to follow the user A, such as in the manner described in detail above, the user A can be at the location 130 and traveling in the direction indicated by the vector 131, as before. However, in the system 200 of FIG. 2, the routing provided to the user B, when the user B is at the location 140, can be based on a predicted destination 231 of the user A, based in part upon the user A′s location 130 and direction of travel, as indicated by the vector 131, but also based on other contexts, such as a geographic context, a historical context, and other like contextual information.

More particularly, in one embodiment, when the user A is at the location 130 and traveling in the direction indicated by the vector 131, it can be predicted that the user A is traveling to the predicted destination 231 because the user A traditionally travels to the predicted destination 231. For example, the user location sharing and routing mechanisms 196 can comprise historical data regarding the location of users, including the user A. Such historical data can reveal, for example, that the user A often shops at the predicted destination 231 and, furthermore, when the user A does shop at the predicted destination 231, the user A historically travels to that location via the street 107. Based upon such a historical context, and based upon the fact that the user A is at the location 130 and traveling in a southbound direction on the street 107, as illustrated by the vector 131, a prediction can be made that the user A is likely heading to the predicted destination 231. Consequently, the routing 241 that can be provided to the user B at the location 140, to enable the user B to follow the user A, can route the user B to the predicted destination 231 of the user A.

As before, a routing provided to a user, such as the routing 241 that was provided to the user B, can be reevaluated if the target of the routing changes, if the user following the routing deviates from it, or if environmental impacts affect the routing. In the example illustrated by the system 200 of FIG. 2, the target of the routing 241 can change when the user A reaches the location 150 and turns in an eastbound direction along the street 106, as illustrated by the vector 151. When the user A performs such a turn at the location 150, it can be determined that the user A is no longer likely traveling to the predicted destination 231 since, for example, the user A has traveled in a direction that is inconsistent with the predicted destination 231. In such a case, a new predicted destination 251 can be derived, and a new routing 261 can be provided to route the user B to the predicted destination 251.

In one embodiment, rather than deriving a predicted destination, such as the predicted destination 251, based on a historical context, such as what a particular user traditionally does, the duration of a predicted destination can be based on observed trends or otherwise non-user specific historical contexts. For example, the predicted destination 251 can have been selected as a predicted destination because it represents the location of a popular shopping mall or other like popular destination. Alternatively, or in addition, a non-user specific historical context could, for example, reveal that most people traveling eastbound on the street 106 are proceeding to the predicted destination 251, which, again, can be a shopping mall or other like often-visited location. Utilizing such non-user specific historical context, a predicted destination 251 can be derived and a routing 261 can be presented to the user B to guide them from the location 160 of the user B at the time that the user A changed their course to the predicted destination 251.

Continuing the example illustrated in the system 200 of FIG. 2, if the user A were to, again, change their course such as, for example, by entering the highway 121 in a southbound direction at the location 170, as illustrated by the vector 171, yet another routing 281 can be generated for the user B. In one embodiment, the routing 281 that can be generated for the user B can be based on a predicted destination 271 that can be predicted with reference to a geographic context. For example, once proceeding in a southbound direction on the highway 121 after entering it at street 106, a traveler may be forced on to the highway 122 in a southeasterly direction and may not be able to exit until proximate to the intersection of the streets 115 and 112. In such an example, the geographic context suggests that a user, such as the user A, proceeding southward on the highway 121 from the location 170 may not be able to exit until the location 271, thereby resulting in the location 271 being selected as the predicted destination. As before, the user B, who can be at the location 180 when the user A, at the location 170, proceeds onto the highway 121, can be provided with a newly generated routing 281 that can guide the user B to the predicted destination 271. As can be seen, and as was the case in the example illustrated in the system 100 of FIG. 1, the user B can be provided with turn-by-turn instructions to guide the user B to another person, such as the user A, and enable the user B to follow the user A, without necessarily proceeding along the same route as the user A.

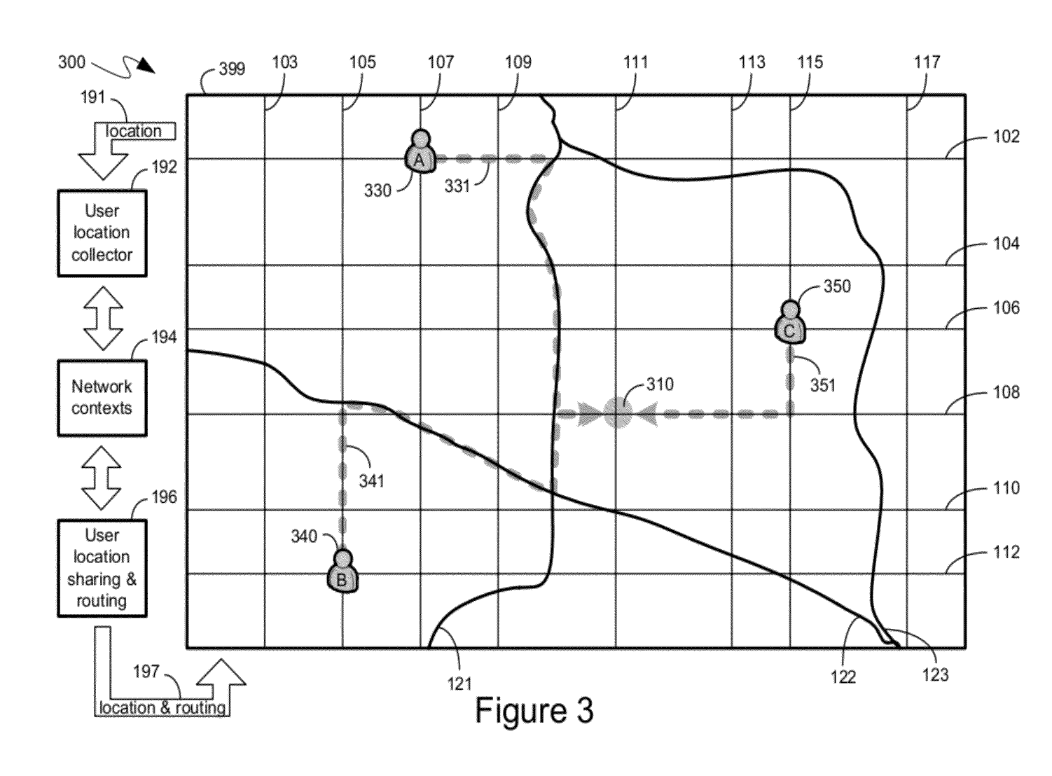

In another embodiment, the routing to a dynamic location can enable multiple users to rendezvous with one another. In such an embodiment, the dynamic location need not be a person or other entity whose location is variable and dynamic, but rather can be an intermediate or final rendezvous location. Turning to FIG. 3, the system 300 shown therein illustrates an exemplary geographic area 399 that is analogous to the geographic areas illustrated previously, except that it comprises different users with different goals, namely the users A, B and C. In the example illustrated by the system 300 of FIG. 3, the users A, B and C can have decided to rendezvous with one another. In one embodiment, each user can individually, and independently, select the other users with whom that first user wishes to rendezvous. If each user in the selected group selects the other users, the rendezvous can proceed. However, if one user does not select the others for a rendezvous, then that user can be excluded from the rendezvous, or, alternatively, each of the other users can be notified that the selected rendezvous cannot proceed because at least one of the selected users does not wish to rendezvous. In another embodiment, an initiating user can select the other users with whom that initiating user wishes to rendezvous. The selected users can then be notified that they have been invited to a rendezvous and can accept or reject such an invitation. The rendezvous can then proceed if at least one other user accepted the invitation. Again, as indicated previously, such selections and interactions can occur through custom interfaces, such as those presented by navigation-capable computing devices that are co-located with the individual users, or they can occur through existing interfaces, such as those presented by social networking contexts.

Turning back to the system 300 of FIG. 3, in the illustrated example, a user A at a location 330, a user B at a location 340, and a user C at the location 350 can select to rendezvous with one another. In one embodiment, a rendezvous location 310 can be generated by a centralized mechanism, such as the user location sharing and routing mechanism 196, and can be communicated to navigation-capable computing devices that are co-located with the individual users, thereby enabling those computing devices to derive their own routing to the identified rendezvous location 310. In an alternative embodiment, centralized mechanisms, such as the user location sharing and routing mechanism 196 can provide both a rendezvous location 310 and one or more individual routings, such as the routings 331, 341 and 351.

Optionally, in one embodiment, the navigation-capable computing devices that are co-located with each individual user can provide those users with a “radar view” that can illustrate the location of each of the other users with whom the rendezvous is occurring. For example, in one embodiment, the radar view that is presented can be similar to the geographic diagram 399 shown in FIG. 3, with an illustration of surrounding roads and an indication of the location, such as the locations 330, 340 and 350, of the users that are rendezvousing. Such a radar view can also comprise additional information, such as, for example, an estimated time of arrival for each user or other relevant information about each user, such as, for example, that user's cellular telephone number.

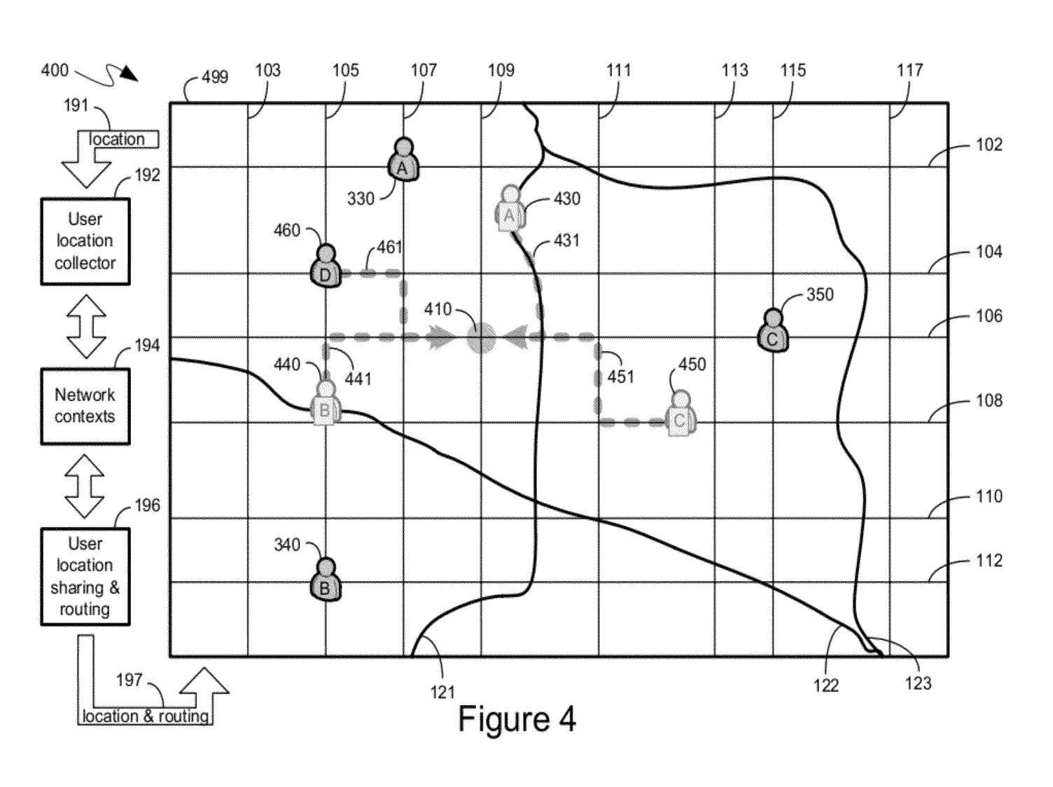

As indicated previously, the routing provided, such as the routings 331, 341 and 351 shown in the system 300 of FIG. 3, can be regenerated if a user following that routing deviates from it, if environmental factors, such as traffic, impact the routing, or if the destination of the routing changes. Within the context of a rendezvous of multiple users, routings can also be regenerated if the group of users that are rendezvousing changes. For example, the exemplary rendezvous illustrated by the system 300 of FIG. 3 comprises a rendezvous among the users A, B and C. After the routings 331, 341 and 351 have been generated, and the users A, B and C have commenced traveling along those routings, a new user D can seek to join the rendezvous. Turning to FIG. 4, the system 400 shown therein illustrates an exemplary response to such a change in the group of users that are rendezvousing. More specifically, as illustrated by the geographic region 499 of the system 400 of FIG. 4, the addition of the user D to the group of users that are rendezvousing can result in the generation, or determination, of a new rendezvous location 410 that can differ from the previously determined rendezvous location 310, which was shown in the system 300 of FIG. 3. As a result of the addition of the user D to the group of users that are rendezvousing, and the resulting determination of the new rendezvous location 410, the routings provided to the users A, B, C and D, namely the routings 431, 441, 451 and 461, respectively, can likewise change. Thus, as shown in the system 400 of FIG. 4, the user A can be at a location 430 proceeding along the routing 331 that was shown in FIG. 3 when the new user D is added to the group of users that are rendezvousing. Consequently, the user A, at the location 430, can now, with the addition of the user D to the group of users that are rendezvousing, proceed along a new routing 431 that can lead the user A from the location 430 to the new rendezvous destination 410. In a similar manner, the user B can have been proceeding along the routing 341, and the user C can have been proceeding along the routing 351, both of which were shown in FIG. 3, when, at the locations 440 and 450, respectively, the users B and C can transition to the new routings 441 and 451 that can, respectively, lead the users B and C from the locations for 440 and 450, respectively, to the new rendezvous destination 410. In such a manner, the above-described system can continue to provide updated turn-by-turn instructions to users seeking to rendezvous even when the group of users rendezvousing remains dynamic and changing.

In another embodiment, rather than routing each user to a singular rendezvous location, such as the rendezvous location 410 shown in the system 400 of FIG. 4, users can, instead, be routed to intermediate rendezvous locations that can serve as “staging” areas for further intermediate rendezvous locations or for final rendezvous locations. In such an embodiment, different users can be routed to different rendezvous locations. Such different rendezvous locations can, not only serve as staging areas, but can also accomplish the rendezvous goal in certain circumstances where the users seeking to rendezvous are, for example, rendezvousing in a large geographic area, such as a park, a mall, or other like area.

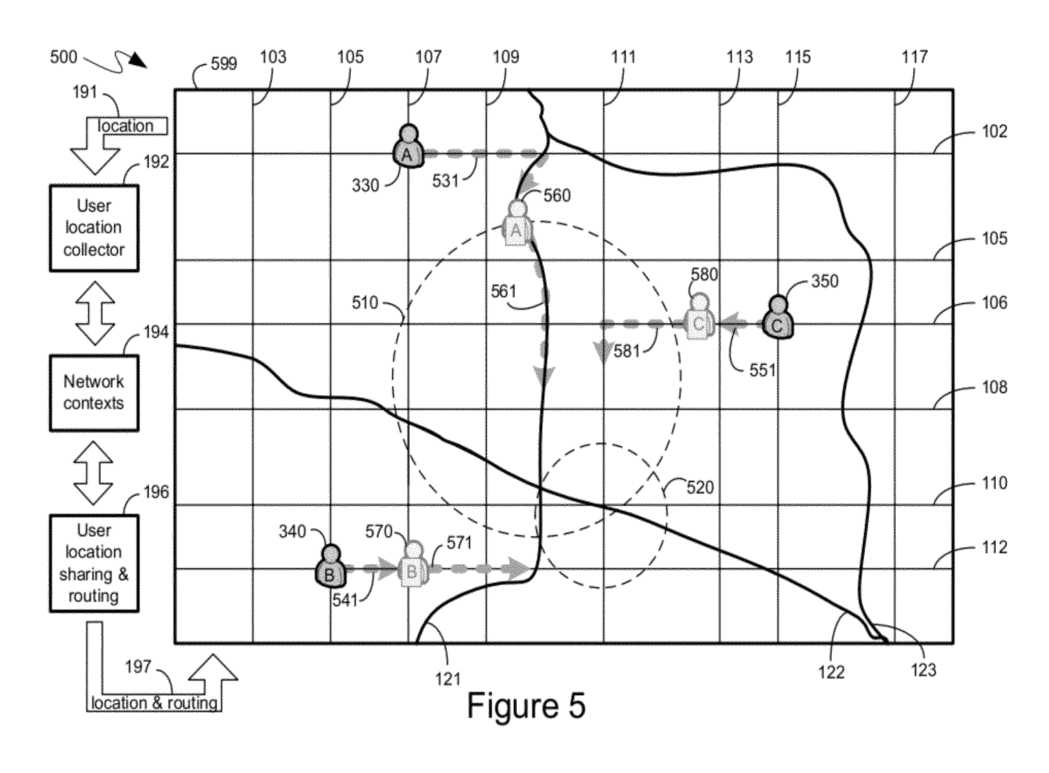

Turning to FIG. 5, the system 500 shown therein comprises a geographic area 599 that illustrates one example of such an embodiment. More specifically, as in the case of the system 300 shown in FIG. 3, the users A, B and C can select to rendezvous, such as in the manner described in detail above. In the present example, however, rather than establishing a single rendezvous location to which all of the users A, B and C will be routed, an intermediate rendezvous area 510 can be established and individual users can be routed to different locations within the rendezvous area 510. For example, as shown, the user A, at the location 330, can be provided with a routing 531 to the intermediate rendezvous area 510, while the user B, at the location 340, can be provided with a routing 541 to a different point on the intermediate rendezvous area 510, and, similarly, the user C, at the location 350, can be provided with a routing 551 to yet another different point on the intermediate rendezvous area 510.

Subsequently, as each individual user proceeds along their routing, a subsequent rendezvous area 520 can be established. The establishing of a subsequent intermediate area 520 can occur due to changes in the group of users that are rendezvousing, such as described in detail above, or it can occur due to one or more of the users reaching their respective rendezvous locations within the prior intermediate rendezvous area 510. For example, as illustrated in the system 500 of FIG. 5, user A can have proceeded along the routing 531 from their original location 330 to a new location 560 that can have been an intermediate rendezvous location in the intermediate rendezvous area 510. When the user A reached the intermediate rendezvous location 510, new routings 561, 571 and 581 can have been generated for the users A, B and C, respectively, to new intermediate, or final, rendezvous locations in the rendezvous area 520. In one embodiment, the new routings 561, 571 and 581 can be generated even though the user B can be at the location 570 that is not yet in the intermediate rendezvous area 510 and, similarly, even though the user C can be at the location 580 that is, likewise, not yet in the intermediate rendezvous area 510. As indicated previously, the rendezvous area 520 can be a final rendezvous area if, for example, the area 520 represents any area from which each of the users can rendezvous with one another on their own and without digital aid, such as, for example a mall, a park, or other like geographic area. Alternatively, as also indicated previously, the rendezvous area 520 can be yet another intermediate rendezvous area that can act as a staging area for further rendezvous area determinations. As can be seen, at least initially, the users A, B and C can have been provided with destination points that differed and were unique to each user.

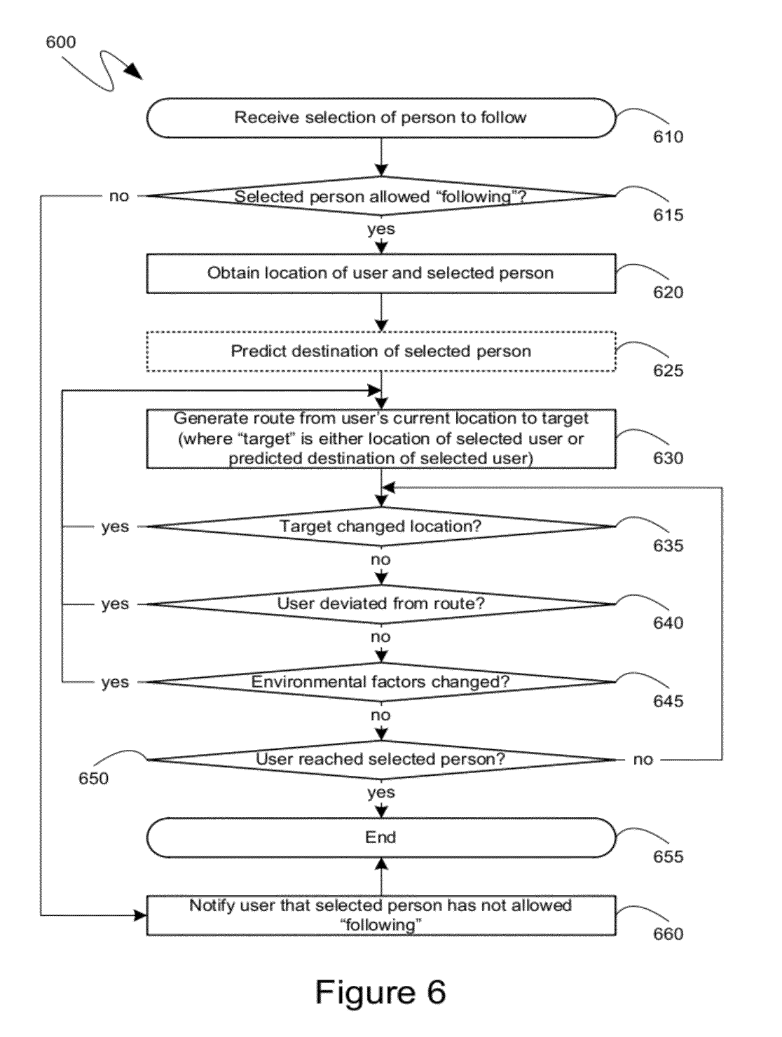

Turning to FIG. 6, the flow diagram 600 shown therein illustrates an exemplary series of steps, such as can be performed by a navigation-capable computing device that can be co-located with the user and can enable the user to follow another user. Initially, as shown, at step 610, a selection of a person to follow can be received from a user. As indicated previously, the selection at step 610 can be performed through a dedicated interface or can utilize and take advantage of existing interfaces for identifying users in other contexts, such as social networking contexts. Subsequently, at step 615, a determination can be made whether the person selected at step 610 has allowed the user to be made aware of that person's location. As indicated previously, the check, at step 615, can reference various criteria that an individual can establish to protect their privacy including, for example, limiting the disclosure of their location during certain times of day, only while that person is within a selected geographic area, only to selected individuals or groups of individuals, or combinations thereof. If, at step 615, it is determined that the person the user selected to follow has not allowed that user to be made aware of that person's location, processing can proceed to step 660 at which point the user can be notified that the selected person has not allowed the user to follow them. The relevant processing can then end at step 655.

Alternatively, if, at step 615, it is determined that the person that was selected at step 610 has allowed the user to follow them, processing can proceed to step 620 at which point the location of the user and the selected person can be obtained. As will be known by those skilled in the art, the location of the user can be obtained through dedicated sensors, such as GPS sensors, that can be part of the navigation-capable computing device executing the steps of the flow diagram 600 of FIG. 6. Alternatively, as will also be known by those skilled in the art, the location of the user can be obtained through signal triangulation, or other deduction methodologies, such as, for example, based on the location of the local wireless network to which such a navigation-capable computing device is communicationally coupled. Conversely, the location of the selected person can be obtained through communications with a remote entity that can have obtained such location information from the selected person, or, more particularly, from one or more computing devices co-located with the selected person, such as in the manner described in detail above.

In one embodiment, the following of the selected person can be based on that person's current location and direction of travel, as described previously, while, in another embodiment, the following of the selected person can be based on a prediction of where that person is going, as also described previously. Consequently, in one embodiment, processing can proceed from the step 620, described above, to the step 630, at which point a route can be generated from the user's current location to a target location that can either be based on the selected individual's current location and direction of travel, or that can be based on a predicted destination of that selected person. In the latter case, prior to proceeding with step 630 an optional step 625 can be performed where a destination of the selected person can be predicted, such as in the manner described in detail above. Additionally, both steps 625 and 630 can be performed by a navigation-capable computing device that is co-located with the user, or they can be performed by remote computing devices, such as server computing devices, and then communicated to the navigation-capable computing device that is co-located with the user.

Once a routing has been generated, such as at step 630, processing can proceed with a series of determinations at steps 635, 640, 645 and 650. As will be recognized by those skilled in the art, while the determinations of step 635, 640, 645 and 650 are illustrated as occurring in a serial manner, they can equally be performed in a parallel manner, in which case the performance of any one such determination need not necessarily be based on the results of any prior determination. As illustrated in the flow diagram 600 of FIG. 6, a determination, at step 635, can check whether the target to which the route generated at step 630 is directed, has changed its location. Similarly, a determination, at step 640, can check whether the user has deviated from the route generated at step 630 and, another determination, at step 645, can check whether environmental factors that can potentially impact the route generated at step 630 have changed. If, as determined by the checks at steps 635, 640 and 645, the target has changed its location, the user has deviated from the route, or environmental factors impacting the route have changed, then processing can return to step 630 and a new route can be generated. Alternatively, processing can proceed with the determination at step 650 that can check whether the user has reached the selected person. If, at step 650, it is determined that the user has reached the selected person, then relevant processing can end at step 655. Conversely, if, at step 650, it is determined that the user has not yet reached the selected person, processing can return to the performance of the checks at steps 635, 640 and 645.

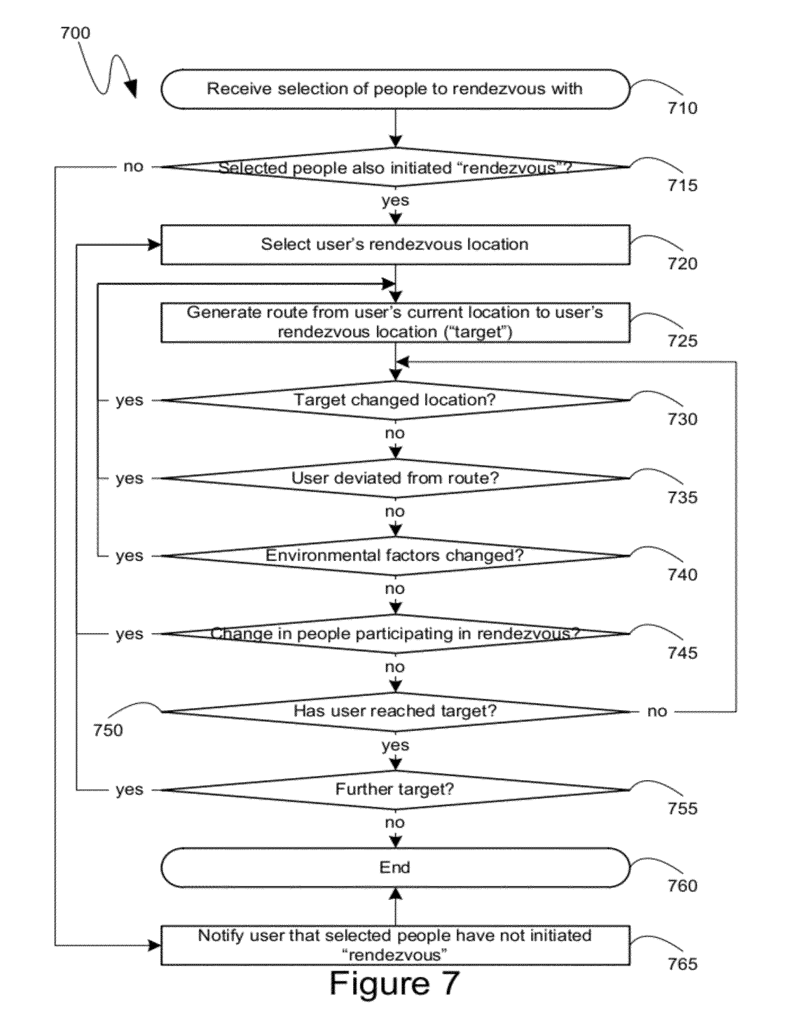

Turning to FIG. 7, the flow diagram 700 shown therein illustrates an exemplary series of steps that can be performed, such as by a navigation-capable computing device that is co-located with the user, that can enable a user to rendezvous with other individuals. Initially, as illustrated by the step 710, a selection of people to rendezvous with can be received from the user. Again, as indicated previously, such a selection can be performed with reference to identifiers in network contexts, such as social networking contexts, and can be performed through either a dedicated interface or an interface presented as part of those contexts. Subsequently, at step 715, a determination can be made whether the individuals selected at step 710 have also agreed to the rendezvous. As indicated previously, individuals can agree to a rendezvous by independently selecting the other people with whom they wish to rendezvous, by responding to a request to rendezvous, such as can have been initiated by the step 710, or by making available their location to the user requesting the rendezvous. If, at step 715, it is determined that at least some of the people selected at step 710 is not willing to participate in the rendezvous, or has not allowed the user access to their location information, then processing can proceed to step 765, at which point the user can be informed that the selected people have not agreed to the rendezvous, or otherwise have allowed the user to access their location information. The relevant processing can then end at step 760.

Conversely, if, at step 715, it is determined that the people selected at step 710 are willing to rendezvous, then the rendezvous location can be selected at step 720. In one embodiment, step 720 can be performed locally, while, in another embodiment, step 720 can be performed remotely and the resulting rendezvous location can be communicated to the navigation-capable computing device that is co-located with the user. As will be recognized by those skilled in the art, since the rendezvous location selected at step 720 is not likely to be the location of any one of the people that are rendezvousing, the performance of step 720 at a remote computing device can provide for greater user privacy since none of the individuals rendezvousing can be provided with the location of the other individuals, such as for purposes of performing step 720. Additionally, as indicated previously, the rendezvous location selected at step 720 can be the same rendezvous location that is provided to one or more other individuals that are part of the rendezvous, or it can be a different, user-specific location that is unique to that user and differs from the rendezvous locations to which other users are being directed. User-specific locations can represent final rendezvous locations, such as in the context of a rendezvous at a larger geographic area, such as a mall or a park, or they can represent intermediate rendezvous locations, such as locations that can act as staging locations from which further intermediate, or final, rendezvous locations can be routed to.

Once a rendezvous location is determined at step 720, processing can proceed to step 725 and a routing can be generated from the user's current location to the user's rendezvous location. As will be recognized by those skilled in the art, such routing can be performed in accordance with traditional mechanisms for determining an efficient route by which a user at one location can be guided to another destination, and can take into account environmental variables such as traffic and road closures. Additionally, as indicated previously, the generation of the route at step 725 can be performed either locally on the navigation-capable computing device that is co-located with the user, or it can be performed remotely and communicated to that computing device, such as through cellular or wireless networks.

Once a route has been generated, at step 725, the user can be provided with turn-by-turn directions as they proceed along that route. While the user is proceeding along the route, a series of determinations at steps 730, 735, 740, 745, 750 and 755 can be performed. As before, the determinations at steps 730, 735, 740, 745, 750 and 755 can be performed, either in series as illustrated, or in parallel, in which case the dependencies shown in FIG. 7 need not be present and any one determination can be performed irrespective of the results of the other determinations. One such determination, at step 730, can determine whether the target has changed location, while another determination, at step 735, can determine whether the user has deviated from the route generated at step 725, and yet another determination, at step 740, can determine whether environmental factors, impacting the route that was determined at step 725, have changed. If any one of the determinations at step 730, 735 and 740 is affirmative, then processing can return to step 725 and a new route can be generated. Conversely, if the determinations at steps 730, 735 and 740 are negative, then processing can proceed with step 745, at which point a determination can be made as to whether the individuals participating in the rendezvous have changed.

If, at step 745, it is determined that the group of individuals participating in the rendezvous have changed, then processing can return to step 720 and a new rendezvous location can be selected, taking into account the changed group of individuals now participating in the rendezvous. Conversely, if, at step 745, is determined that there has been no change in the individuals participating in the rendezvous, then processing can proceed to step 750, at which point a determination can be made if the user has reached the target established at step 720. If, at step 750, it is determined that the user has not yet reached the target, processing can loop back to step 730. If, however, at step 750, it is determined that the user has already reached the target established at step 720, a subsequent determination, at step 755, can determine whether there is a further target. For example, the target location selected at step 720 can have been just an intermediate rendezvous location, and, at step 755, a determination can be made as to whether there are further rendezvous locations, including further intermediate rendezvous locations or final rendezvous locations. If, at step 755, is determined that the target location specified at step 720 was, in fact, the final rendezvous location, then the relevant processing can end at step 760. Alternatively, if, at step 755, is determined that there are further rendezvous locations, then processing can return to step 720, at which point further rendezvous location can be selected.

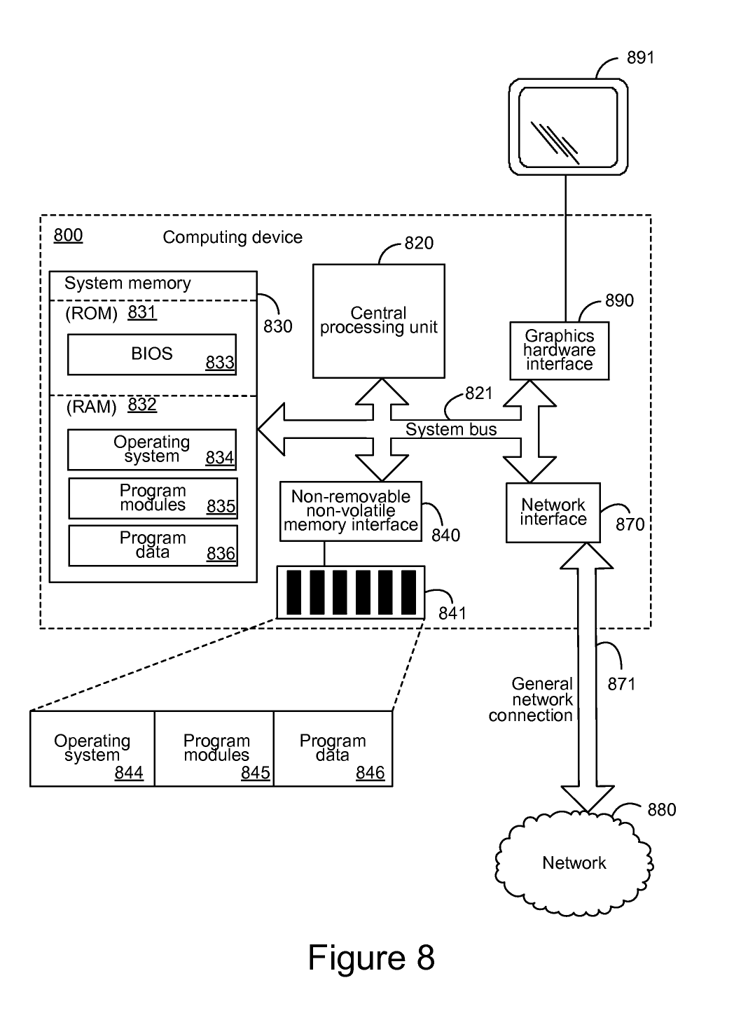

Throughout the descriptions above, reference has been made to a navigation-capable computing device that can be co-located with a user. Turning to FIG. 8, one such navigation-capable computing device is described with reference to the exemplary computing device 800 illustrated in FIG. 8. The exemplary computing device 800 of FIG. 8 includes, but is not limited to, one or more central processing units (CPUs) 820, a system memory 830, and a system bus 821 that couples various system components including the system memory to the processing unit 820. The system bus 821 may be any of several types of bus structures including a memory bus or memory controller, a peripheral bus, or a local bus using any of a variety of bus architectures. The computing device 800 can include graphics hardware, including, but not limited to, a graphics hardware interface 890 and a display device 891. The display device 891 can display the turn-by-turn directions described above as being presented to the user, as well as the radar view detailed above and other navigation-centric displays. Additionally, the display device 891 can provide a graphical user interface for receiving the user's selection, such as those described above.

The computing device 800 also typically includes computer readable media, which can include any available media that can be accessed by computing device 800 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 800. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing device 800, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, other program modules 835, and program data 836.

The computing device 800 may also include other removable/non-removable, volatile/nonvolatile computer storage media. By way of example only, FIG. 8 illustrates a solid state storage 841 that reads from or writes to non-removable, nonvolatile solid state memory media. Other removable/non-removable, volatile/nonvolatile computer storage media that can be used with the exemplary computing device include, but are not limited to, magnetic storage media, such as hard disk drives, magnetic tape cassettes, flash memory cards, digital versatile disks, digital video tape, solid state RAM, solid state ROM, and the like. The solid state storage 841 is typically connected to the system bus 821 through a non-removable memory interface such as interface 840.

The drives and their associated computer storage media discussed above and illustrated in FIG. 8, provide storage of computer readable instructions, data structures, program modules and other data for the computing device 800. In FIG. 8, for example, the solid state storage 841 is illustrated as storing operating system 844, other program modules 845, and program data 846. Note that these components can either be the same as or different from operating system 834, other program modules 835 and program data 836. Operating system 844, other program modules 845 and program data 846 are given different numbers hereto illustrate that, at a minimum, they are different copies.

Of relevance to the descriptions above, the computing device 800 may operate in a networked environment using logical connections to one or more remote computers. For example, the computing device 800 is shown in FIG. 8 to be connected to the network 880 via a general network connection 871 that can be a local area network (LAN), including wireless LANs, a wide area network (WAN), such as a cellular data network, or other network connection. The computing device 800 is connected to the general network connection 871 through a network interface or adapter 870 which is, in turn, connected to the system bus 821. In a networked environment, program modules depicted relative to the computing device 800, or portions or peripherals thereof, may be stored in the memory of one or more other computing devices that are communicatively coupled to the computing device 800 through the general network connection 871. It will be appreciated that the network connections shown are exemplary and other means of establishing a communications link between computing devices may be used.

Additionally, although not specifically illustrated, the computing device 800 can comprise hardware and/or software that can enable the computing device 800 to ascertain its position. For example, the computing device 800 can comprise a GPS receiver for receiving GPS signals and deriving therefrom, in a manner known to those skilled in the art, the location of the computing device 800. Alternatively, the computing device 800 can ascertain its position through signal triangulation or other like deductive mechanisms that can be implemented though software, often in combination with hardware, such as an antenna through which signals to be utilized for triangulation can be received. Such antennae can be considered to be part of the network interface 870 and can include wireless and cellular data antennae.

As can be seen from the above descriptions, mechanisms for providing detailed directions to enable following of a user or rendezvous of multiple users have been presented. In view of the many possible variations of the subject matter described herein, we claim as our invention all such embodiments as may come within the scope of the following claims and equivalents thereto.

We claim:

1. One or more computer-readable media comprising computer-executable instructions for providing, to a user, turn-by-turn directions to a dynamic target destination, the computer-executable instructions directed to steps comprising:
receiving, from the user, a selection of at least one individual;
verifying that the selected at least one individual has consented to reveal their location;
generating turn-by-turn directions to guide the user to the dynamic target destination, the dynamic target destination being associated with the selected at least one individual; and
periodically regenerating the turn-by-turn directions as the dynamic target destination changes.

2. The computer-readable media of claim 1, wherein the dynamic target destination is the location of the at least one individual.

3. The computer-readable media of claim 1, comprising further computer-executable instructions for predicting a destination of the selected at least one individual; and wherein the dynamic target destination is the predicted destination of the selected at least one individual.

4. The computer-readable media of claim 3, wherein the computer-executable instructions for performing the predicting comprise computer-executable instructions for performing the predicting based at least in part on a historical context of prior movement by the selected at least one individual and the location of the at least one individual.

5. The computer-readable media of claim 1, wherein the dynamic target destination is a rendezvous location associated with a rendezvous between the user and the selected at least one individual.

6. The computer-readable media of claim 5, wherein the computer-executable instructions for verifying that the selected at least one individual has consented to reveal their location comprise computer-executable instructions for verifying that the selected at least one individual has consented to the rendezvous.

7. The computer-readable media of claim 5, wherein the dynamic target destination differs from a rendezvous location provided to the selected at least one individual.

8. The computer-readable media of claim 5, wherein the dynamic target destination is an intermediate rendezvous location from which routing to a final rendezvous location is staged.

9. The computer-readable media of claim 5, wherein the dynamic target destination changes because additional individuals join the rendezvous.

10. The computer-readable medium of claim 1, wherein the received selection comprises an identifier of the at least one individual in a social networking context.

11. A navigation-capable computing device comprising:
one or more central processing units;
an interface through which a user selects at least one individual;
a display providing turn-by-turn directions to guide the user to a dynamic target destination associated with the selected at least one individual; and
one or more computer-readable media comprising computer-executable instructions that, when executed by the one or more central processing units, perform steps comprising:
verifying that the selected at least one individual has consented to reveal their location;
generating the turn-by-turn directions; and periodically regenerating the turn-by-turn directions as the dynamic target destination changes.

12. The computing device of claim 11, further comprising at least one wireless connection; wherein the one or more computer-readable media further comprise computer-executable instructions for determining a location of the computing device based on a triangulation of signals of the at least one wireless connection.

13. The computing device of claim 11, wherein the display further provides a radar view illustrating locations of at least some of the user and the selected at least one individual.

14. The computing device of claim 11, further comprising an interface through which the user limits disclosure of a user's location, as identified by the computing device, the limiting being based on at least one of: a time period during which the user's location cannot be disclosed, a geographic region within which the user's location cannot be disclosed and a group to whom the user's location cannot be disclosed.

15. A system for providing, to a user, turn-by-turn directions to a dynamic target destination, the system comprising:
a first navigation-capable computing device co-located with the user;
a second navigation-capable computing device co-located with at least one other individual;
a server computing device comprising location information specifying a location of both the first and second navigation-capable computing devices; and
one or more computer-readable media comprising computer-executable instructions directed to steps comprising: receiving, from the user, a selection of the at least one other individual; verifying that the at least one other individual has consented to reveal their location; generating turn-by-turn directions to guide the user to the dynamic target destination, the dynamic target destination being associated with the at least one other individual; and periodically regenerating the turn-by-turn directions as the dynamic target destination changes.

16. The system of claim 15, wherein the server computing device comprises the one or more computer-readable media that comprise the computer-executable instructions directed to the verifying, the generating, and the periodically regenerating.

17. The system of claim 15, wherein the dynamic target destination is the location of the second navigation-capable computing device.

18. The system of claim 15, wherein the dynamic target destination is a rendezvous location associated with a rendezvous between the user and the at least one other individual.

19. The system of claim 15, further comprising a social networking context within which the at least one other individual is associated with an identifier; and wherein the selection of the at least one other individual comprises the identifier.

20. The system of claim 15, further comprising a social networking context through which the at least one other individual limits disclosure of the location of the second navigation-capable computing device, the limiting being based on at least one of: a time period during which the location of the second navigation-capable computing device cannot be disclosed, a geographic region within which the location of the second navigation-capable computing device cannot be disclosed and a group to whom the location of the second navigation-capable computing device cannot be disclosed.
